(19) United States
(12) Patent Application Publication
(10) Pub. No.: US 2018/0273844 A1
(43) Pub. Date: Sep. 27, 2018

(54) CONTINUOUS FLOW SYNTHESES OF NANOSTRUCTURE MATERIALS

(71) Applicants: Dow Global Technologies LLC, Midland, MI (US); Rohm and Haas Electronic Materials LLC, Marlborough, MA (US); The Board of Trustees of the University of Illinois, Urbana, IL (US)

(72) Inventors: Kishori Deshpande, Midland, MI (US); Peter Trefonas, III, Medway, MA (US); Jieqian Zhang, Southborough, MA (US); Vivek Kumar, Urbana, IL (US); Nuri Oh, Champaign, IL (US); Andy You Zhai, Urbana, IL (US); Paul Kenis, Urbana, IL (US); Moonsub Shim, Urbana, IL (US)

(21) Appl. No.: 15/746,514

(22) PCT Filed: Feb. 13, 2016
(86) PCT No.: PCT/US2016/017906

§ 371 Date: Jan. 22, 2018

Related U.S. Application Data
(60) Provisional application No. 62/273,919, filed on Dec. 31, 2015.

(51) Int. Cl. C09K 11/88; C09K 11/70

(52) U.S. Cl. CPC C09K 11/883; C09K 11/88; C09K 11/703

(57) ABSTRACT

Methods and systems for producing nanostructure materials are provided. In one aspect, a process is provided that comprises a) heating one or more nanostructure material reagents by 100° C. or more within 5 seconds or less; and b) reacting the nanostructure material reagents to form a nanostructure material reaction product. In a further aspect, a process is provided comprising a) flowing a fluid composition comprising one or more nanostructure material reagents through a reactor system; and b) reacting the nanostructure material reagents to form a nanostructure material reaction product comprising Cd, In or Zn. In a yet further aspect, methods are provided that include flowing one or more nanostructure material reagents through a first reaction unit; cooling the one or more nanostructure material reagents or reaction product thereof that have flowed through the first reaction unit; and flowing the cooled one or more nanostructure material reagents or reaction product thereof through a second reaction unit.

The present application claims the benefit of and priority to U.S. provisional application 62/273,919 filed Dec. 31, 2015, which is incorporated herein by reference in its entirety

### 1. FIELD

Methods and systems are provided for producing nanostructure materials through continuous flow processes.

### 2. BACKGROUND

Anisotropic, rod-shaped semiconductor nanocrystals possess interesting electronic properties that depend on their size, aspect ratio and chemical composition. These nanoparticles find use in important applications such as light emitting devices, photocatalysis, optically induced light modulation, photovoltaics, wavefunction engineering, biolabeling, and optical memory elements. In general, anisotropic semiconductor nanoparticles are considered to expand the uses of spherical nanocrystals (quantum dots) in all the aforementioned applications in which the elongated shape could in principle add new or improved properties.

In general, batch synthesis of nanoparticles suffers from disadvantages of slow mixing and heating, and batch-to-batch reproducibility issues. These issues escalate further when scaling up. See also U.S. Pat. No. 7,833,506; US2002/0144644; US 2014/0026714; and US2014/0326921.

It thus would be desirable to have new methods to produce nanoparticles.

### SUMMARY

We now provide new methods and systems for producing nanostructure materials, including continuous flow processes.

In one aspect, a process is provided that comprises a) heating one or more nanostructure material reagents by 100° C. or more within 5 seconds or less; and b) reacting the nanostructure material reagents to form a nanostructure material reaction product.

In a further aspect, a process is provided for preparing nanostructure materials comprising Cd, In or Zn, where the process comprises a) flowing a fluid composition comprising one or more nanostructure material reagents through a reactor system; and b) reacting the nanostructure material reagents to form a nanostructure material reaction product comprising Cd, In or Zn.

In a yet further aspect, continuous flow processes and systems are provided that comprise two or more reaction steps or units, and wherein a cooling step or cooling unit is interposed between at least two of the reaction steps or units. Thus, in a preferred process, 1) one or more nanostructure material reagents are reacted and/or flow through a first reaction unit, 2) the one or more nanostructure materials or reaction product thereof are cooled and/or flow through a cooling unit, and 3) the cooled one or more nanostructure materials or reaction product thereof are then reacted and/or flow through a second reaction unit. The one or more nanostructure material reagents or reaction product thereof suitably may be heated during reacting and/or flowing through the first and/or second reaction units. Such processes suitably may include additional reaction steps and/or reaction units with interposing cooling steps or cooling units. Preferably, the one or more nanostructure material reagents or reaction product thereof that flow out of the second reaction unit are cooled such as by flowing through a second cooling unit.

A preferred system may comprise sequentially in a fluid flow path: a first reaction unit, a cooling unit, and a second reaction unit followed by another cooling unit. In use, one or more nanostructure materials or reaction product thereof sequentially flow through 1) the first reaction unit, and then 2) the cooling unit, and then 3) the second reaction unit 4) the second cooling unit. The one or more nanostructure material reagents or reaction product thereof suitably may be heated during reacting and/or flowing through the first and/or second reaction units. Such systems suitably may include additional reaction units with interposing cooling units. In preferred systems, a cooling unit will reduce the temperature of a fluid composition flowing therethough by at least 10° C., 20° C., 30° C., 40° C., 50° C., 60° C., 70° C., 80° C., 90° C. or 100° C. In preferred systems, in a reaction unit, one or more materials of a fluid composition passing therethrough the reaction unit will undergo a chemical reaction. Preferably, one or more nanostructure materials or reaction product thereof that flows out of the second reaction unit is cooled, for example the system may comprise a second cooling unit distinct from the first cooling unit.

In a still further aspect, continuous flow processes for preparing nanostructure materials, the process comprising flowing a fluid composition comprising one or more nanostructure material reagents through a reactor system at a predetermined rate and/or heating the flowing one or more nanostructure material at a predetermined temperature to provide nanostructure material reaction product that provides a desired emission wavelength.

We have found that in the continuous flow processes disclosed herein nanostructure material products of desired emission wavelength can be produced through selecting a particular flow rate through a reaction unit and/or selecting a temperature within the reaction unit. In general, we have found that larger nanostructure material reaction products can be produced with lower flow rates and/or higher temperatures of the fluid composition flowing through the reaction unit.

In preferred processes, the one or more nanostructure material reagents may be heated by 100° C. or more within 4 seconds or less, 3 seconds or less, 2 seconds of less, or even 1 or 0.5 second or less.

Heating speeds (e.g. 100° C. in 5 seconds or less) as referred to herein can be suitably determined by the change of temperature of a composition or mixture in a fluid flow path over the specified period of time. For instance, heating speeds may be determined by the change of temperature of a fluid composition upon entry into a reaction vessel over a period of time.

Preferred reaction systems of the invention also can operate reactions at high temperatures, for example reactions can be conducted at 100° C., 200° C., 300° C., 400° C., 500° C., 600° C., 700° C., 750° C. or 800° C. or more.

Additionally, in preferred processes, the nanostructure material reaction product can be cooled rapidly, such as cooling a nanostructure material reaction product by at least 100° C. within 5 seconds or less, 4 seconds or less, 3 seconds or less, or even within 2 or 1 seconds or less. Cooling speeds (e.g. 100° C. in 5 seconds or less) as referred to herein can be suitably determined by the change of temperature of a composition or mixture in a fluid flow path over the specified period of time. For instance, cooling speeds may be determined by the change of temperature of a fluid composition upon entry into a cooling vessel over a period of time.

Significantly, in preferred aspects, a nanostructure material reaction product can be cooled rapidly as disclosed herein without any need for dilution of the reaction product.

In particularly preferred aspects, the reaction process comprises a continuous flow, i.e. where one or more fluid compositions flow through a reaction without significant interruption or without the fluid composition remaining stationary (i.e. stationary would be without a positive flow rate, where a positive flow rate could include a flow rate of at least 0.1, 0.2, 0.3, 0.4 or 0.5 ml/minute). A fluid composition flows through a reaction without significant interruption where the fluid composition has a positive flow rate for at least 50, 60, 70, 80, 90 or 95 percent of time the fluid composition enters the reactor system with a positive flow rate until that fluid composition completes reaction in the system. As should be understood, a continuous process as referred to herein is distinguished from a batch process where reagents remain without substantial flow through a reactor system during the course of a reaction.

In preferred aspects, a fluid composition comprising one or more nanostructure material reagents flows through a reactor system during heating, reacting and cooling.

In particularly preferred aspects, a modular reactor system is utilized in the processes and systems of the invention. Preferred reactor systems also may include multiple reactor units, for example in either a parallel or series arrangement. A millifluidic reactor system is often preferred.

Preferably, reaction of one or more nanostructure material reagents will occur under conditions where air and/or water are at least substantially excluded from the reactor system.

Materials of a wide range of flow characteristics may be utilized in preferred reactor systems. Preferably, viscosity of fluids comprising nanostructure material reagents or reaction products may be from 500 to 10,000 centipoise (cP) at 80° C., or 1000 to 7,000 cP at 80° C.

As mentioned, preferred reaction systems also will be configured to accommodate flow and reaction of materials at high temperatures, including in excess of 100° C., 200° C., 300° C., 400° C., 500° C., 600° C., 700° C., 750° C., 800° C. or more. In particular aspects, fluid flow pathways (e.g., input and output tubing) will be suitable for use at high temperatures. For instance, such fluid flow pathways may be forms from stainless steels such as austenitic stainless steels, nickel alloys and/or iron-chromium-aluminum alloys.

Preferred processes of the invention also may include regular monitoring of one or more reaction composition components to detect selected properties, such as temperature, viscosity, presence or absence and amounts of nanostructure material reagents and/or nanostructure material reaction products. In particular aspects, one or more of such detected properties are modified based on a detected value. For example, properties (such as visible fluorescence and/or absorbance properties) of the desired reaction product can be detected, and further reactor synthetic output is subsequently modified based on the detected response characteristics by tuning operating conditions.

A variety of materials may be reacted and produced in accordance with the present processes and systems, including nanostructure material reagents and reaction products that comprise Zn, Cd, S, Se, In or Te. Reaction products may include a wide range of nanostructure materials include for example quantum materials (isotropic and anisotropic), fluorescent dyes and phosphors. Nanostructure materials of a variety of geometries also may be reacted and produced in accordance with the present invention. For instance, nanostructure materials can be reacted and/or produced that comprise shapes of at least substantially spherical, ellipsoidal or non-elongated polyhedron, or a shape or a rod or a wire. A rod or wire shape may be where one axis of a particle is at least twice the dimensional shape or length relative to other axes of the particle.

Preferred processes and systems of the invention can provide a reaction product that is within a narrow range of one or more physical characteristics, including for example a nanostructure material reaction product that has a particle size distribution standard deviation of 10 nm or less, or even 5, 4 or 3 nm or less. Preferred processes and systems of the invention also can provide a nanostructure material reaction product where the full width at half maximum (FWHM) of the visible wavelength primary fluorescence of the reaction product is less than 50 nm, or less than 40 or 30 nm, or even 20 nm or less.

As referred to herein, the term nanostructure material includes quantum dot materials as well as nanocrystalline nanoparticles (nanoparticles) that comprise one or more heterojunctions such as heterojunction nanorods.

The term nanostructure material reagent material includes materials that can be reacted to provide a nanostructure material. For instance, a nanostructure material reagent material includes a variety of reactive compounds that may suitably comprise Id, Cd, Ga, Cu, Ag, Mn, Ce, Eu, Zn, S, Se, In and/or Te.

The term nanostructure material reaction product includes materials that have been reacted to provide a nanostructure material. For example, preferred nanostructure material reaction products may include any of Id, In, Cd, Ga, Cu, Ag, Mn, Ce, Eu, Zn, S, Se and/or Te. In certain aspects, preferred nanostructure material reaction products include Zn and/or Se such as ZnSe and ZnS materials including ZnSe and ZnS nanorods. In additional aspects, preferred nanostructure material reaction products include InP materials including InP nanorods passivated with ZnSe; and Cd materials such as CdSe including CdSe coated with ZnSe. Methods and systems of the invention also are particularly suitable for synthesis of core-shell nanostructure material compositions.

The invention also includes reaction systems and components thereof as disclosed herein, including heating units and cooling units.

In particular, in one aspect, a reaction unit is provided which comprises one or more heating elements extending for at least a portion of the flow length or path of the reaction unit. For instance, a heating element may extend at least 30, 40, 50, 60, 70, 80, 90 or 95 percent of the length or fluid flow path of the reaction unit. Such a heating element may be separate from but preferably positioned proximate to a fluid flow path of the reaction unit, for example, a heating element may be positioned 50, 40, 30, 20, 15, 10, 5, 4, 3, or cm or less from a reactor unit fluid flow path.

The invention also provides devices obtained or obtainable by the methods disclosed herein, including a variety of light-emitting devices, photodetectors, chemical sensors, photovoltaic device (e.g. a solar cell), transistors and diodes, a biological sensor, a pathological detector as well as biologically active surfaces that comprise the systems disclosed herein.

Other aspects of the invention are disclosed infra.

### BRIEF DESCRIPTION OF THE DRAWINGS

FIG. 1 shows schematically a preferred reaction system of the invention.

FIGS. 2(A) through 2(H) show preferred heating and cooling units and systems of the invention.

FIG. 3A shows an exemplary reaction flow path.

FIG. 3B shows a further preferred reaction system of the invention.

FIG. 4 (which includes FIGS. 4(A) through (G)) shows (A) TEM image of anisotropic CdSe particles synthesized in the continuous flow reactor at 230° C. and 3 min. (B) HRTEM image shows a lattice constant of 3.4 A° corresponding to (002) plane that is indicative of CdSe wurtzite structure in the product. (C) Absorption and (D) emission spectra (absorption normalized) of the synthesized CdSe particles for different residence times of 0.5 min, 3 min and 5 min. CdSe particles were further coated with a shell of ZnS. The associated (E) length and (F) width distributions of the sample shown in (A) indicate a fairly uniform size of the particles with an average width and length of 2.5±0.5 nm and 17±3.2 nm. 87 particles were analysed to obtain the size distributions. (G) Powder XRD patterns of the synthesized CdSe particles indicate hexagonal wurtzite structure. The broad band at 25° is due to trioctylamine/tiroctylphosphine ligand. The standard pattern for hexagonal wurtzite for CdSe is given for reference.

FIG. 5 (which includes FIGS. 5(A) through (C)) shows in Figure (A) temperature sweep, FIG. 5(B) time sweep, and FIG. 5(C) concentration sweep were performed to analyse the effects of process parameters on the product quantum yield (QY) and emission wavelength (λ). Unless stated, the synthesis conditions were kept same as the base case (mentioned in the examples which follow) except the parameter for which the sweep was done.

FIG. 6 is a schematic of different set of conditions tested for ripening stage of ZnSe nanorods. The four quadrants represent different combinations of residence times and temperatures used in the ripening stage. High residence time with high temperature seemed to decompose the product. Similarly, use of high temperatures with short residence times or high residence times with lower temperatures produced over-ripened product. Additionally, low temperatures combined with low residence times produced under-ripened nanorods. An optimal combination of temperature and residence time yielded monodisperse ZnSe nanorods.

FIG. 7 (which includes FIGS. 7(A) through 7(F)). TEM images of (A) ZnSe nanowire/nanorod mixture obtained from ripening of unpurified nanowire product and (B) ZnSe nanorods. Also shown is an FIG. 7C HRTEM image of the ZnSe nanorods with distinct lattice fringes. Nanowires were synthesized in the continuous flow reactor at 160° C. for a residence time of 60 min. The nanowire product was then purified, redissolved in oleylamine, and flowed through the reactor at 260° C. for a residence time of 3 min to yield nanorods shown in Figure B. Absorption spectra of synthesized ZnSe nanowires (160° C., 60 min) and nanorods (260° C., 3 min) are shown in FIG. 7D. ZnSe nanowires exhibit two peaks at 327 nm and 345 nm, indicating presence of magic-size ZnSe nanowires. The associated length and width distributions of the sample in FIG. 7B are shown in FIGS. 7E and 7F respectively. Nanorods have an average length and width of 13.4±1.8 nm and 2.3±0.2 nm respectively. 114 particles were analyzed to obtain the size distributions.

FIG. 8 (which includes FIGS. 8A and 8B) shows results of Example 4 which follows.

FIG. 9 shows results of Example 5 which follows.

FIG. 10 (which includes FIGS. 10A, 1B and 10C) and FIG. 11 show results of Example 6 which follows.

### DETAILED DESCRIPTION

We have now found that the rapid heating and cooling continuous flow reaction systems as disclosed herein can provide nanostructure material reaction product of enhanced properties, including in comparison to product produced by a batch synthesis process. In particular, we found that nanostructure material reaction product produced in a batch process had a significantly broader size distribution than the same nanostructure material reaction product produced through a continuous flow reaction system as disclosed herein.

As discussed above, we also have found processes for preparing nanostructure materials, comprising flowing a fluid composition comprising one or more nanostructure material reagents through a reactor system at a predetermined flow rate and/or heating the flowing one or more nanostructure material at a predetermined temperature to provide nanostructure material reaction product that provides a desired emission wavelength. In such processes, effective flow rates and/or heating or reaction temperatures can be readily determined empirically to provide a nanostructure material of a desired emission wavelength, i.e. distinct flow rates and/or heating or reaction temperatures can be tested and the emission wavelength of produced nanostructure material reaction product evaluated. By such testing and evaluation, specific reaction flow rates and/or reaction temperatures can be selected to provide a particular nanostructure material reaction product of a desired emission wavelength. We have found that relatively slower flow rates and/or lower reaction temperatures can red-shift the nanostructure material reaction product and conversely comparatively more rapid flow rates and/or higher reaction temperatures can blue-shift the produced nanostructure material reaction product. See, for instance, the results of Example 6 which follows.

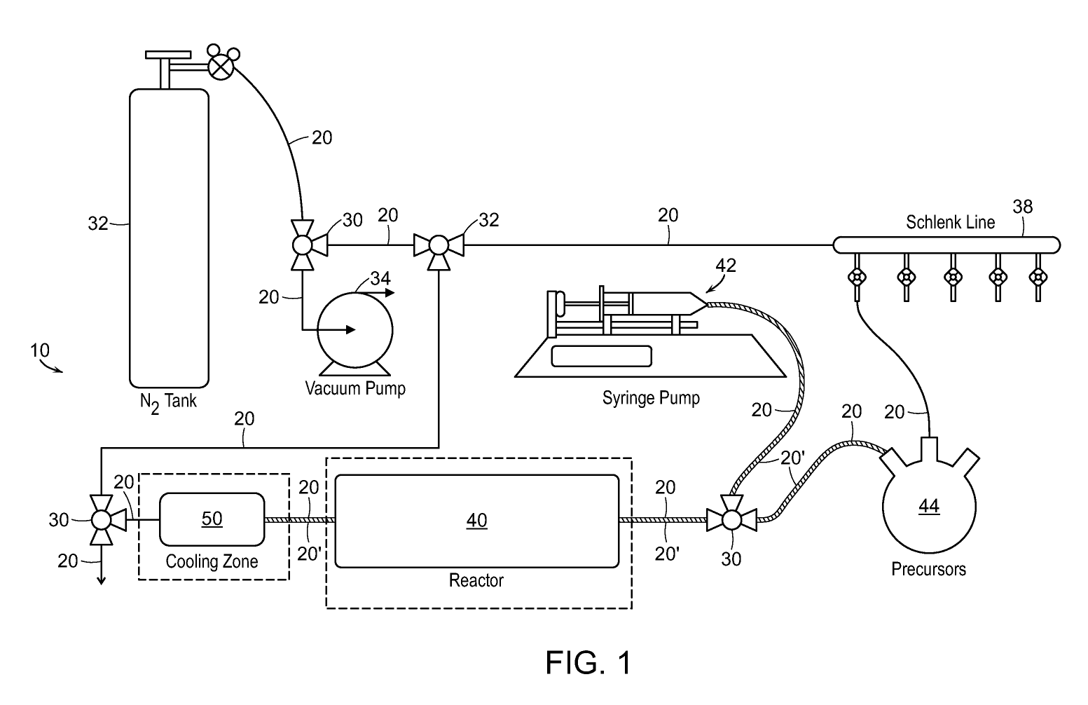

Referring now to the drawings, FIG. 1 depicts schematically a preferred continuous flow reactor system. The reactor system 10 comprises a modular system including a plurality of interconnected tubular components 20. The system is described as modular since the interconnected tubular components may be easily removed and replaced and are suitably provided in standard sizes. The tubular components 20 suitably generally interconnect through multiple-input and output junctions 30 which suitably may be three-way junctions. In FIG. 1, the cross-hatched lines 20 (also further designated as 20′) indicate heated lines. Preferably, the lines 20′ can have carefully controlled heating, e.g. fluid passing therethrough maintained within a temperature range of 10° C. or less, more preferably maintained within a temperature range of 5° C., 4° C., 3° C., or 2° C. or less.

The reaction system can be maintained under an inert atmosphere, including substantially free from air and/or moisture. Thus, as shown in FIG. 1, inert gas (e.g. nitrogen, argon) from vessel 32 can flow through reactor system 10. The reactor system also suitably may comprise vacuum pump 34.

Nanostructure material reagents may enter reactor vessel 40 via reagent vessels 42 and 44. Vessels 42 and 44 may be of a variety of configurations. For instance, vessel 42 suitably may be a syringe pump or other unit that can advance a reagent fluid composition under positive pressure. Vessel 44 may be a glass or metal (e.g. stainless steel) reaction vessel. Reagents may be feed ino vessel 44 via feed apparatus 38 which may for example include a Schlenk line.

It can be seen that fluid streams from reagent vessels 42 and 44 enter junction 30 (also labelled as 30′), which merges the two separate fluid streams into a mixed composition that flows to reactor 40.

As an example, one of the reagent fluid streams from vessels 42 and 44 may comprise a first reagent solution and the other may comprise a distinct second reagent solution. After a sufficient residence time in the flow reactor 40, the mixed solution may comprise a reacted solution that includes for example nanoparticles, or functionalized nanoparticles that further include a surface capping agent.

Reactor 40 suitably may comprise a pump (e.g., a peristaltic pump) to drive the fluid streams through the reactor 40 at a desired flow rate. Reactor 40 also suitably may include a purification system (e.g., a tangential flow filtration system).

The tubular components 20 may be of a variety dimensions. In an exemplary configuration, a tubular component suitably may have an inner diameter of at least about 0.5 mm and no more than about 10 mm. More typically, the inner diameter is from about 1 mm to about 10 mm and may be from about 1 mm to about 4 mm. Lengths of the tubular components may vary as needed for a particular reactor system configuration.

In preferred systems, a reactor and reactor system will be a millifluidic reactor and system. A millifluidic system or reactor or other similar term refers to a system or reactor that has fluidic channels with a tubular diameter in millimeter dimensions. As referred to herein, millimeter dimensions may suitably include for example 0.1 mm to 1000 mm, or 1 mm to 10, 20, 30, 40, 50, 60, 70, 80, 90, 100, 200 mm or more.

In certain preferred systems, a reactor unit will be substantially constructed from stainless steel.

The reaction progress can be monitored and conditions modified as desired. For instance, the visible fluorescence properties of the nanostructure material reaction product can be detected, and further reactor synthetic output can be subsequently modified based on the detected response characteristics by tuning operating conditions. In particular, a reactor vessel can be integrated with real-time UV-vis absorbance spectroscopy analysis to enable product monitoring.

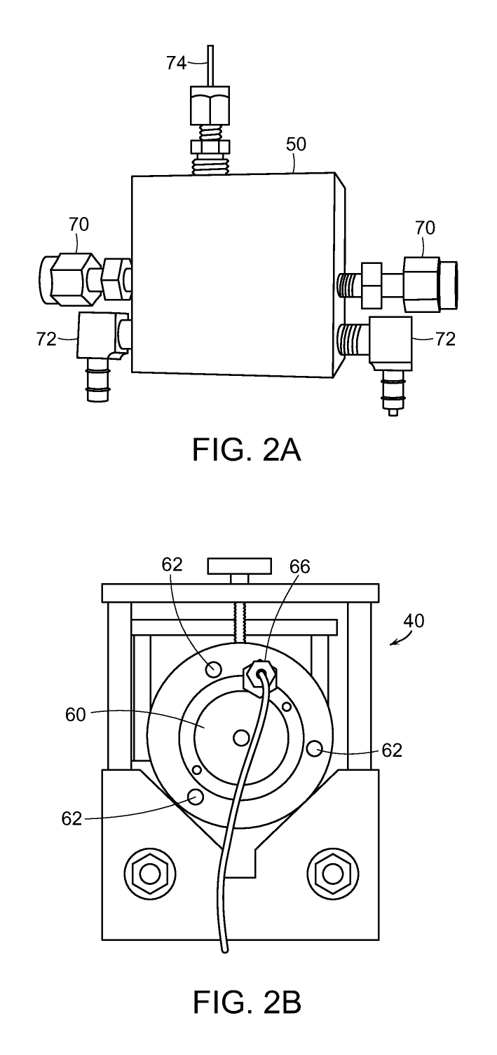

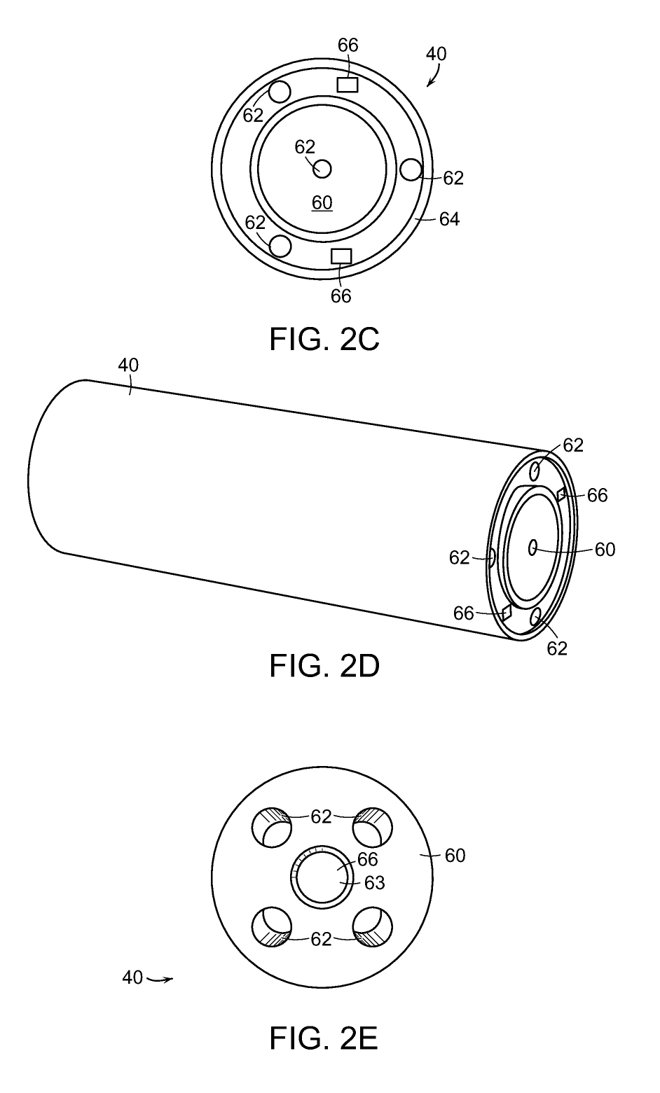

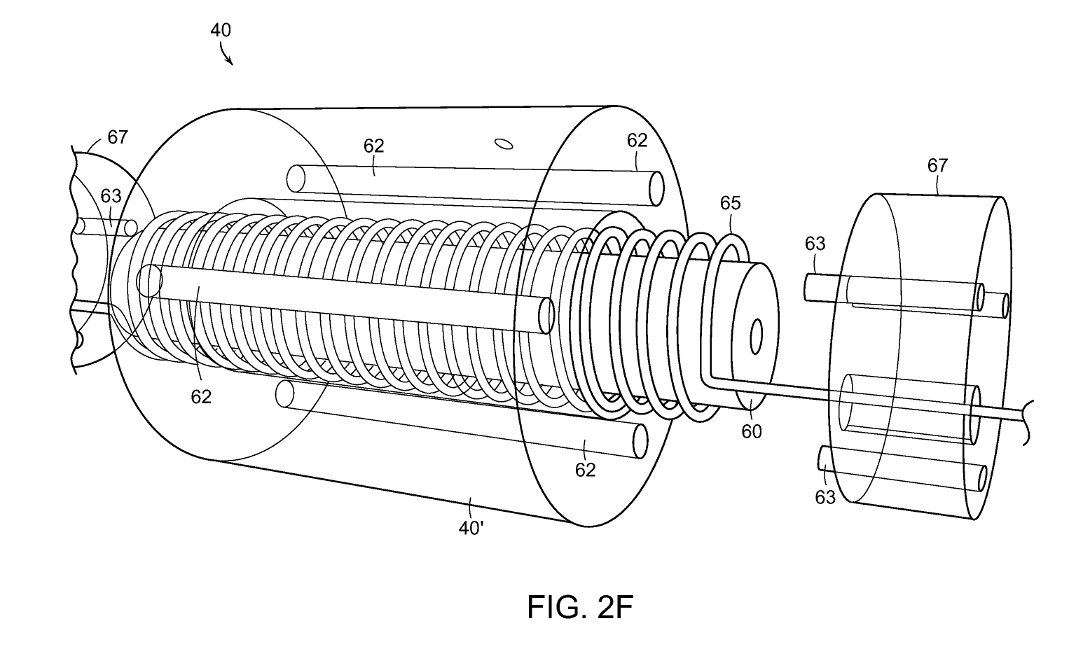

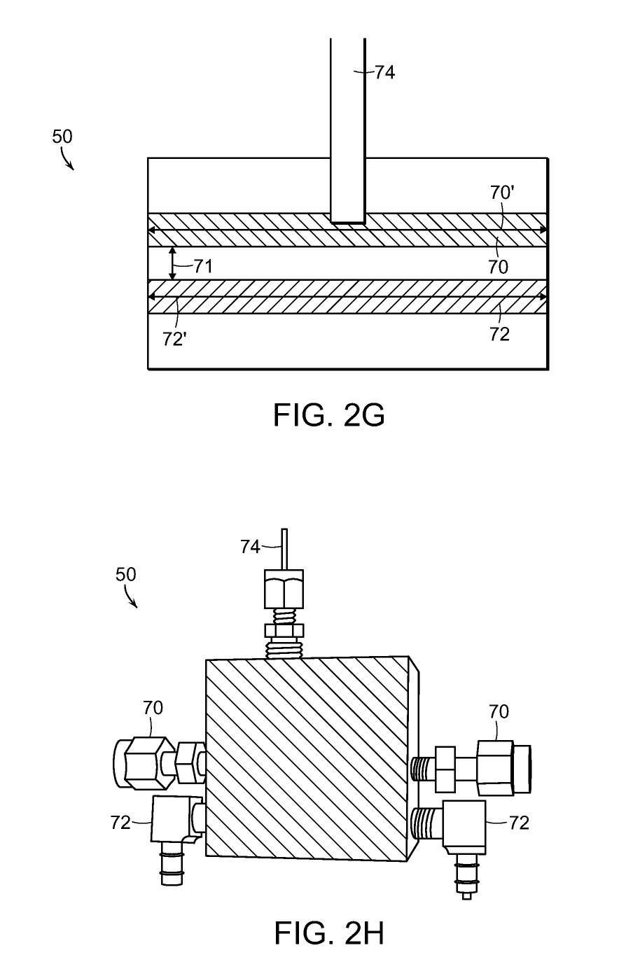

Following desired residence time within reactor 40, fluid flows via tubular component 20′ to cooling unit 50. Temperature of outflowing reaction products from reactor 40 can be rapidly quenched as discussed above with the cooling unit 50. Such cooling also can effectively avoid undesired residual reactions. FIG. 2A shows a side view of one preferred cooling unit 50, and FIG. 2B shows a side view of a preferred reactor unit 40.

As shown in FIGS. 2B, 2C and 2D, particularly preferred reactor units 40 that enable a continuous reaction flow include core unit 60 that suitably comprises graphite. One or more heating units 62 may run for a portion or substantially the entire flow path or length of the reactor unit 40, for example 20, 30, 40, 50, 60, 70, 80, 90, 95 percent or more of the length or flow path of reactor unit 40. As can be seen in FIGS. 2C and 2D, heating units may be positioned both within and around core unit 60. Reactant fluid composition can flow through one or more flow paths 66 which suitably will be formed from stainless steel. Flow paths 66 shown in FIGS. 2B, 2C and 2D which are positioned adjacent a core unit 60 may suitably be of a coil design such as coil fluid or reaction flow path 65 depicted in FIG. 2F. Suitably, reactor unit 40 may be nested with an encasing unit or sleeve 64 which suitably may be stainless steel.

FIG. 2E shows a front view of a preferred reactor unit 40 that includes heating units 62 nested around core 60. This system includes a port for a mixing unit 63 such as a static mixture that suitably operates to agitate or admix one or more reagents or other materials within flow path 66. In the design shown in FIG. 2E, the reaction or fluid flow path 66 passes within or through core unit 60 rather than around or adjacent to the core unit as depicted by flow paths 66 in FIGS. 2B, 2C and 2D or flow path 65 in FIG. 2F.

FIG. 2F shows in phantom view another preferred reactor or reaction unit 40 that includes multiple, spaced cartridge heaters 62 extending the substantial length of the reactor unit 40 and surrounding reactor core 60 which suitably may be constructed at least in part from graphite or other suitable materials. Preferred removable endcaps 67 suitably may be employed and releasably attach to reactor body 40′ such as by screws 63. Core 60 is suitably proximate to a reaction flow path such as encased by the depicted tubing 65 through which a fluid composition of one or more nanostructure reaction products may flow. Reactor body or casing 40′, endcaps 67 or reaction flow path structure 65 suitably may be formed of stainless steel.

As shown in FIGS. 2A, 2G and 2H, particularly preferred cooling units 50 that enable a continuous reaction flow include reagent channel 70 and coolant channel 72. The cooling unit 50 suitably may be formed substantially of copper, or other suitable material. Reagent channel 70 and coolant channel 72 are suitably separated by a distance 71, which may be for example from 0.1 mm to 70 mm, more typically 0.5 mm to 10, 20, 30, 40, 50 or 60 mm. During use of cooling unit 50, nanostructure material reaction products will flow through reagent channel 70 and be cooled by coolant channel 72. Water or other suitable fluid composition either chilled or at room temperature may be used to flow through coolant channel 72. Temperature or other properties of the nanostructure material can be monitored via thermal analysis device 74 which also may include other apparatus for analysis of properties in addition to temperature. In certain preferred systems, flow rates of the nanostructure material reaction product through cooling unit 50 may be 1 to 20 ml/minute, more typically 2 to 10 ml/minute. In certain preferred systems, the lengths 70′ and 72′ of channels 70 and 72 respectively suitably may be from 5 to 80 mm, more typically 5 to 10, 15, 20 or 25 mm. In one preferred system, 70′ and 72′ are each 15 mm.

In preferred aspects, a continuous flow method for nanostructure material synthesis may include flowing multiple fluid compositions of multiple reagents (i.e. each fluid composition may comprise one or more reagents and different fluid compositions comprising one or more different reagents with respect to another fluid composition) into a mixing portion of a flow reactor to form a mixed solution, flowing the mixed solution through a reaction portion of the flow reactor for a predetermined residence time to form a reacted solution comprising nanostructure material reaction product, and continuously removing the reacted solution from the flow reactor so as to achieve a throughput of nanoparticles of at least about 0.5 mg/minute.

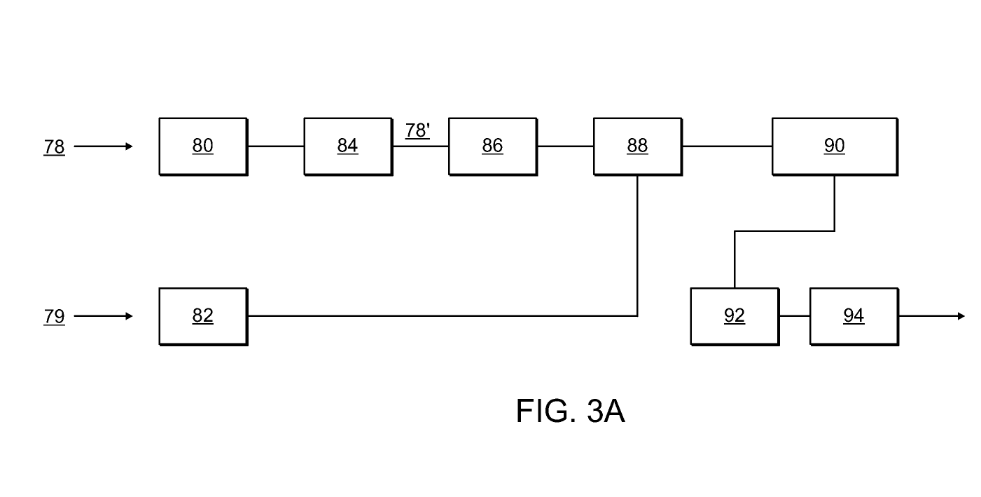

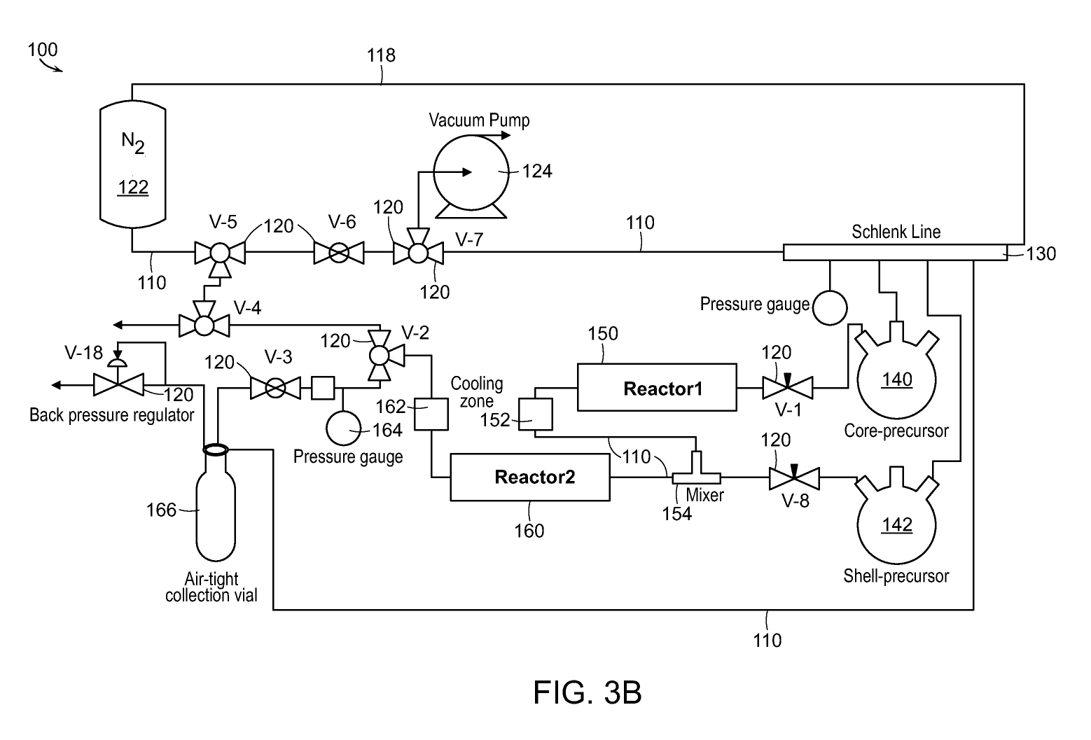

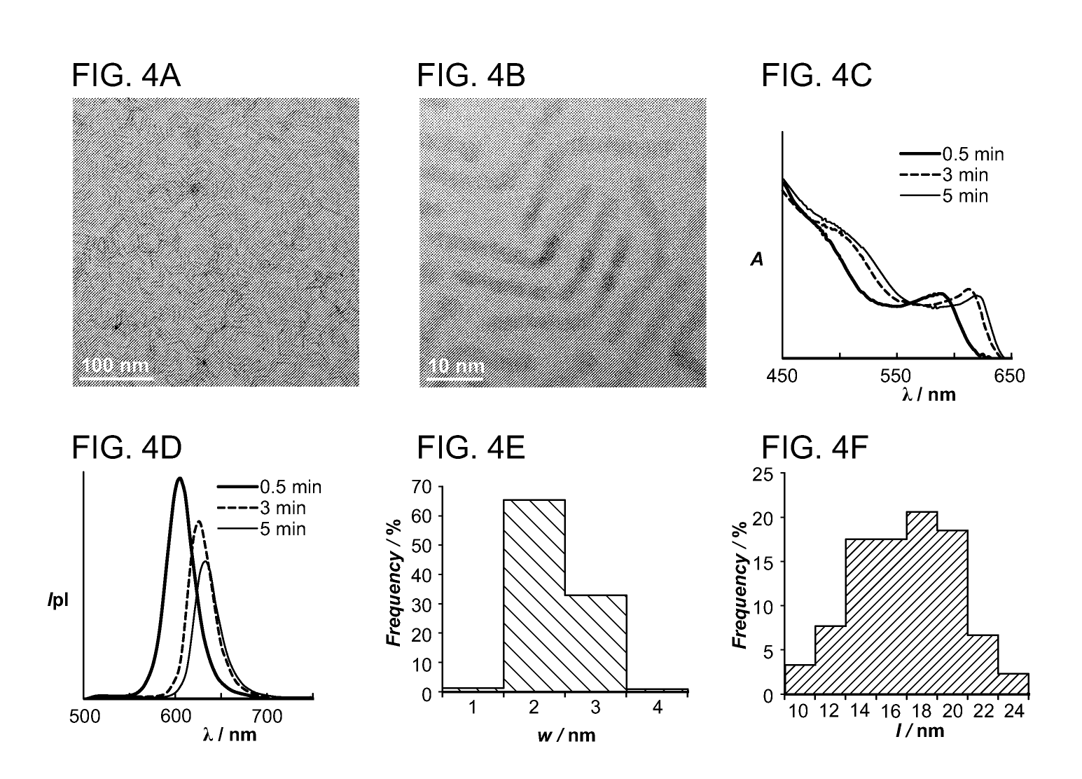

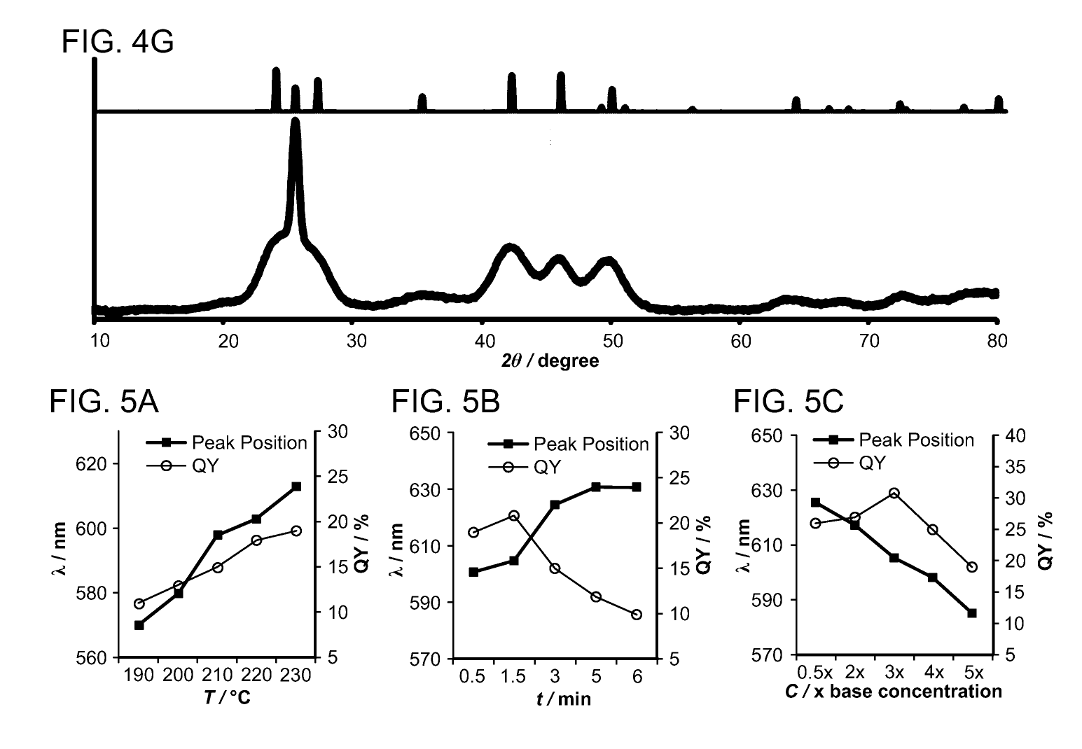

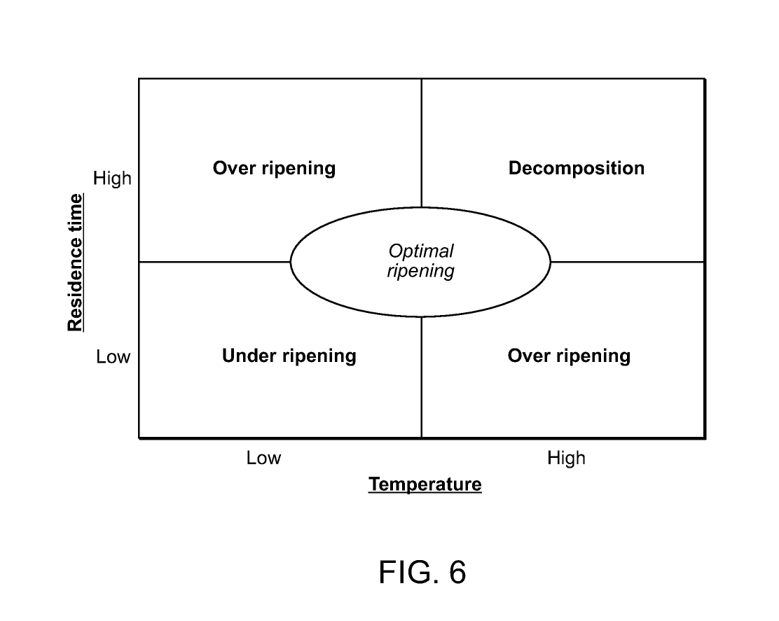

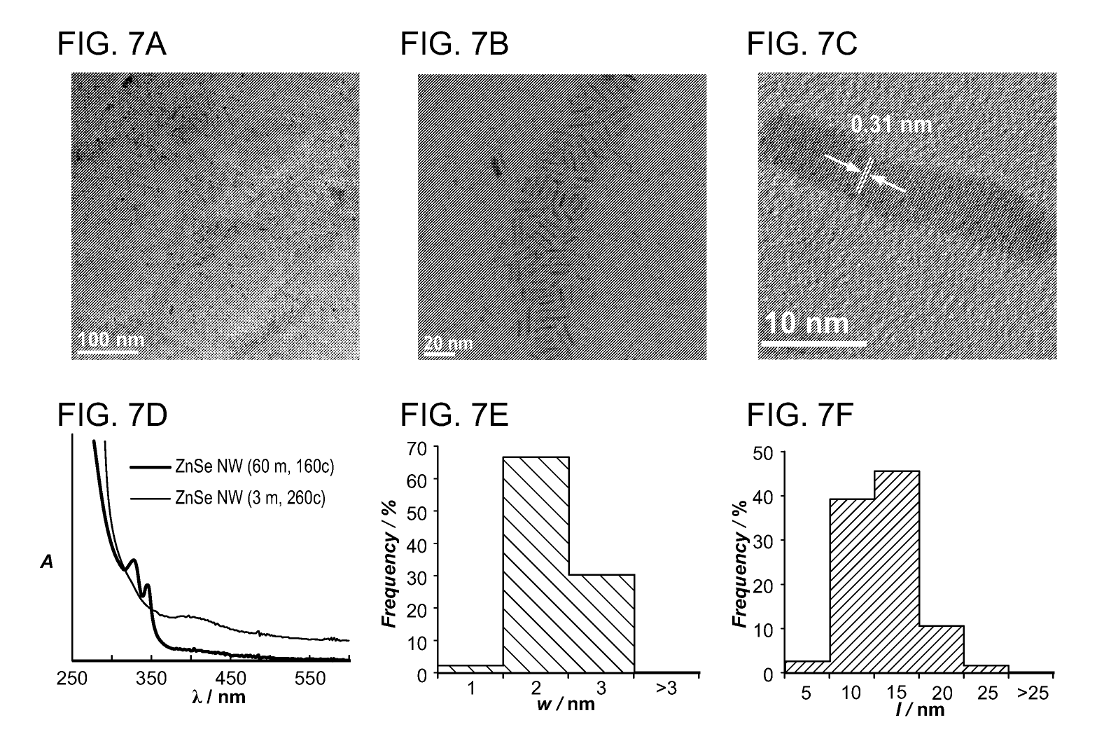

FIG. 3A depicts schematically a preferred reaction system. It will be understood that preferred reaction systems may include or omit one or more of the units described in FIG. 3A. Thus, nanostructure material reagents 78 and 79 pass through pump units 80 and 82 respectively. Reagents 78 and 79 respectively suitably may be different materials. Reagent 78 then passes through a reactor unit 84 to produce intermediate reagent 78′. That intermediate 78′ then passes into cooling unit 86 and then into mixing unit 88 where 78′ is admixed with reagent 79. That admixture of 78′ and 79 then is reacted in second reactor unit 90. The resultant nanostructure material reaction product passes through second cooling unit 92 where the reaction product is cooled and may be subsequently monitored by analysis unit 94. The analysis unit 94 suitably may include ultraviolet-visible and fluorescence spectroscopy.

In certain aspects, such reactor units that include two or more reactor units are preferred and may be particularly suitable for synthesis of compositions comprising multiple distinct materials, including compositions of core-shell construction. In such systems, a cooling unit preferably may be interposed between sequential reactor units.

FIG. 3B depicts another preferred reaction system with multiple reactor units. Preferred reaction systems may include or omit one or more of the units described in FIG. 3B. The depicted continuous flow reactor system 100 comprises a modular system including a plurality of interconnected tubular components 110, any of which may be heated lines as desired. The tubular components 110 suitably generally interconnect through multiple-input and output junctions 120 which suitably may be three-way junctions.

The reaction system can be maintained under an inert atmosphere, including substantially free from air and/or moisture. Thus, as shown in FIG. 3B, inert gas (e.g. nitrogen, argon) from vessel 122 can flow through reactor system 100, including through line 118. The reactor system also suitably may comprise vacuum pump 124.

Nanostructure material reagents suitably may enter reactor vessels 150 and 160 via reagent vessels 140 and 142 respectively. Vessels 140 and 142 may be of a variety of configurations such as a glass or metal (e.g. stainless steel) reaction vessel. Reagents may be fed into the vessels 140 and 142 via feed apparatus 130 which may for example include a Schlenk flask. The reagent vessels are maintained under inert conditions with the help of a Schlenk line.

In one suitable synthetic sequence, one or more nanostructure material reagents may react and flow thorough reactor 150, the reaction product flow through and be cooled in cooling unit 152 and then the cooled reaction product mixed with a further reagent at mixing zone 154 and then flow into a second reactor 160 following by cooling via second cooling unit 162.

As an example, a core component of a composition may be formed in first reactor 150 and then the shell component of a core-shell composition may be added in second reactor 160.

Reactor 150 and 160 each suitably may comprise a pump (e.g., a peristaltic pump) to drive the fluid streams through the reactors 150 and 160 at a desired flow rate. Reactors 150 and 160 also suitably may include a purification system (e.g., a tangential flow filtration system). The system 100 suitably may further comprise pressure gauge 164 as well as collection vessel 166. Vessel 166 may be in fluid communication with feed apparatus 130 such as through flow line 110.

A flow rate of each of reagent composition into and through a reactor unit (such as reactor 40 in FIG. 1) suitably can vary widely and may be for example at least 0.5 or 1 mL/min, at least 2 mL/min, at least 5 mL/min, at least 10 mL/min, at least 30 mL/min, or at least 50 mL/min. In certain systems, the flow rate suitably also may be no more than about 500 mL/min, or no more than about 200 mL/min. In some embodiments, the flow rate may be much higher, such as at least about 1,000 mL/min, at least about 2,500 mL/min, or at least about 5,000 mL/min. Typically, the flow rate is no more than about 20,000 mL/min, or no more than about 10,000 mL/min. The predetermined residence time of one or more nanostructure material reagents within a reactor unit (such as reactor 40 in FIG. 1) can be about 60 min or less, about 30 min or less, about 10 min or less, about 5 min or less, and in some embodiments about 3 min or less. Typically, the predetermined residence time is at least about 1 min, at least about 2 min, at least about 5 min, at least about 10 min, or at least about 20 min.

The reacted solution includes nanostructure material reaction product at any of a variety of concentrations such as at least about 1 nM.

The present reactor systems enable high-throughput synthesis for a variety of nanostructure materials including, for example, nanostructure materials comprising Zn and/or Se such as ZnSe and ZnS nanorods; nanostructure materials comprising InP materials including InP coated with ZnSe; and nanostructure materials comprising Cd such as CdSe including CdSe coated with ZnSe.

As discussed above, the term nanostructure material as used herein includes both quantum dot materials as well as nanocrystalline nanoparticles (nanoparticles) that comprise one or more heterojunctions such as heterojunction nanorods.

An applied quantum dot suitably may be Group II-VI material, a Group III-V material, a Group V material, or a combination thereof. The quantum dot suitably may include e.g. at least one selected from CdS, CdSe, CdTe, ZnS, ZnSe, ZnTe, HgS, HgSe, HgTe, GaN, GaP, GaAs, InP and InAs. Under different conditions, the quantum dot may include a compound including two or more of the above materials. For instance, the compound may include two or more quantum dots existing in a simply mixed state, a mixed crystal in which two or more compound crystals are partially divided in the same crystal e.g. a crystal having a core-shell structure or a gradient structure, or a compound including two or more nanocrystals. For example, the quantum dot may have a core structure with through holes or an encased structure with a core and a shell encasing the core. In such embodiments, the core may include e.g. one or more materials of CdSe, CdS, ZnS, ZnSe, CdTe, CdSeTe, CdZnS, PbSe, AgInZnS, and ZnO. The shell may include e.g. one or more materials selected from CdSe, ZnSe, ZnS, ZnTe, CdTe, PbS, TiO, SrSe, and HgSe.

Passivated nanocrystalline nanoparticles (nanoparticles) that comprise a plurality of heterojunctions suitably facilitate charge carrier injection processes that enhance light emission when used as a device. Such nanoparticles also may be referred to as semiconducting nanoparticles and may comprise a one-dimensional nanoparticle that has disposed at each end a single endcap or a plurality of endcaps that contact the one-dimensional nanoparticle. The endcaps also may contact each other and serve to passivate the one-dimensional nanoparticles. The nanoparticles can be symmetrical or asymmetrical about at least one axis. The nanoparticles can be asymmetrical in composition, in geometric structure and electronic structure, or in both composition and structure. The term heterojunction implies structures that have one semiconductor material grown on the crystal lattice of another semiconductor material. The term one-dimensional nanoparticle includes objects where the mass of the nanoparticle varies with a characteristic dimension (e.g. length) of the nanoparticle to the first power. This is shown in the following formula (1): M α Ld where M is the mass of the particle, L is the length of the particle and d is an exponent that determines the dimensionality of the particle. Thus, for instance, when d=1, the mass of the particle is directly proportional to the length of the particle and the particle is termed a one-dimensional nanoparticle. When d=2, the particle is a two-dimensional object such as a plate while d=3 defines a three-dimensional object such as a cylinder or sphere. The one-dimensional nanoparticles (particles where d=1) includes nanorods, nanotubes, nanowires nanowhiskers, nanoribbons and the like. In one embodiment, the one-dimensional nanoparticle may be cured or wavy (as in serpentine), i.e. have values of d that lie between 1 and 1.5.

Exemplary preferred materials are disclosed in U.S. Patent Application 2015/0243837 and U.S. Pat. No. 8,937,294, both incorporated herein by reference.

The one-dimensional nanoparticles suitably have cross-sectional area or a characteristics thickness dimension (e.g., the diameter for a circular cross-sectional area or a diagonal for a square of square or rectangular cross-sectional area) of about 1 nm to 10000 nanometers (nm), preferably 2 nm to 50 nm, and more preferably 5 nm to 20 nm (such as about 6, 7, 8, 9, 10, 11, 12, 13, 14, 15, 16, 17, 18, 19 or 20 nm) in diameter. Nanorods are suitably rigid rods that have circular cross-sectional areas whose characteristic dimensions lie within the aforementioned ranges. Nanowires or nanowhiskers are curvaceous and have different or vermicular shapes. Nanoribbons have cross-sectional area that is bounded by four or five linear sides. Examples of such cross-sectional areas are square, rectangular, parallelopipeds, rhombohedrals, and the like. Nanotubes have a substantially concentric hole that traverses the entire length of the nanotube, thereby causing it to be tube-like. The aspect ratios of these one-dimensional nanoparticles are greater than or equal to 2, preferably greater than or equal to 5, and more preferably greater than or equal to 10.

The one-dimensional nanoparticles comprise semiconductors that suitably include those of the Group II-VI (ZnS, ZnSe, ZnTe, CdS, CdTe, HgS, HgSe, HgTe, and the like) and III-V (GaN, GaP, GaAs, GaSb, InN, InP, InAs, InSb, AlAs, AlP, AlSb, and the like) and IV (Ge, Si, Pb and the like) materials, an alloy thereof, or a mixture thereof.

Nanostructure materials including quantum dot materials are commercially available and also may be prepared for example by a standard chemical wet method using a metallic precursor as well as by injecting a metallic precursor into an organic solution and growing the metallic precursor. The size of the nanostructure material including quantum dot may be adjusted to absorb or emit light of red (R), green (G), and blue (B) wavelengths.

The following examples are illustrative of the invention

### Example 1: Reaction System

The reactor module of this example included a stainless steel (SS) tube with an inner diameter of 2.16 mm and an outer diameter of 3.20 mm. The tube is coiled tightly around a graphite cylindrical bar that hosts a slot for the cartridge heater in the center. The total volume of the reactor was 8.5 mL. The SS coil assembly (SS tube coiled around the graphite bar) is encased within a SS cylindrical shell, which contains three symmetrically placed slots for cartridge heaters. The cartridge heaters run through the entire length of the casing in order to ensure uniform heating. The casing is provided with two end-caps through which the ends of the SS tubing exit. The end-caps can maintain the SS coil under sufficient tension so that it stays tightly wound around the graphite bar, thereby making sure that the SS coil makes maximum contact with the graphite bar and the SS casing which results in effective heating of the SS coil. The design can allow the reactor to achieve heating time of a reagent fluid composition of less than 0.3 seconds from 25° C. to 270° C. The entire reactor module is insulated using 2 layers of insulation—ceramic wool and ceramic roll manufactured by Unifrax LLC. The use of long cartridge heaters that run through the entire length of the reactor, and double insulation layers prevent any hotspots in the reactor, indicated by a low Biot number (10⁻⁶) for the system. Temperature of the reactor is controlled via proportional integral derivative (PID) controller (CSi-32k) manufactured by Omega.

### Example 2: Reaction System

In this example, the reactor system generally corresponds to the system and units shown in FIGS. 1, 2A through 2H and 3A. The reactor system included a 2.5 in thick cylindrical stainless steel bar with four symmetrically placed slots for cartridge heaters. The stainless steel bar has a 0.28 in wide cylindrical groove (reactant channel) in the middle through which the reactants flow running through the length of the bar. The reactant channel has an Omega static mixer (FMX 8442S) to prevent parabolic flow profile through the reactor, thereby mitigating any Residence Time Distribution effects. The entire reactor module is insulated using 2 layers of insulation—ceramic wool and ceramic roll manufactured by Unifrax LLC. The use of long cartridge heaters that run through the entire length of the reactor, and double insulation layers prevent any hotspots in the reactor, indicated by a low Biot number (10⁻⁶) for the system. Temperature of the reactor is controlled via PID controller (CSi-32k) manufactured by Omega. The design allows the reactor to achieve heating time of a reagent composition in less than 1 second from 25° C. to 270° C.

A cooling module was utilized to quickly quench the temperature of the final product coming out of the reactor module, thereby avoiding any side or residual reactions. The cooling module is designed to optimally cool down reaction products to a temperature such that the residual reactions are stalled, while simultaneously preventing any solidification of products in the lines. The module is designed along the lines of a parallel-flow heat exchanger. Width and distance between the coolant and product channels (SI) were accurately determined using COMSOL simulations for flow rates used in the syntheses. The cooling module is made of copper due to its high thermal conductivity (k˜385 W/m-K). Temperature at the outlet is measured using a k-type thermocouple probe.

Heated lines and syringe. The SS lines (shown in cross-hatched lines 20′ in FIG. 1) carrying reactants to syringe and the reactor are heated using rope heaters. Temperature of these lines is monitored and controlled using PID controllers (CSi-32k) and thermocouples set at various places in the lines. 50 mL SS syringes manufactured by KD Scientific are used in the syntheses. PHD 2000 syringe pumps (manufactured by Harvard Apparatus) are used to dispense reactants to the reactor at a set flow rate. Reactants are flowed using Cole-Parmer peristaltic pumps that may include Teflon tubing compatible with reactants being used.

In-line static mixer. Sulzer SMX plus static mixer was used to mix different reactant streams, thereby allowing for multi-step synthesis. 5 mixer elements, each measuring 4.8 mm in diameter and 4.8 mm in length were used in series.

In-line analysis tools. An absorbance flow cell with a path length of 200 um was used to measure absorbance of the product. The short path length obviated the need for any dilution of the product downstream the reactor outlet. Additionally, a cross-flow fluorescence flow cell was used to measure the fluorescence output of the products. The flow cells were connected to portable Flame spectrometers (manufactured by Ocean Optics) to measure the readings.

### Example 3: Syntheses of Nanostructure Materials

In this Example, the reactor system generally corresponds to the system described in Example 2 above. Cadmium oxide (99.5%), selenium (99.99%), oleic acid (90%), oleylamine (70%), trioctylphosphine (TOP) (90%), trioctylamine (98%), zinc stearate (technical grade), and zinc diethyldithiocarbamate (ZnDDTC₂) (97%) were purchased from Sigma-Aldrich and used as received. Unless otherwise stated, the CdSe nanorod synthesis used 0.1028 g CdO (0.8 mmol) dissolved in 2.0 mL of oleic acid at 200° C. forming a clear solution. For synthesis of CdSe nanorods, TOP-Se solution was created by mixing 1.1844 g Se with 15 mL TOP in a glovebox before dissolving via sonication. For a standard synthesis, the Cd oleate solution (0.4 M Cd) and 0.8 mL of the anion solution (1 M Se) were mixed with 40 mL TOA and pumped through the tube reactor, which was held at 220° C. with standard residence times (reactor volume/volumetric flow rate) of two and one half minutes (base case conditions).

For ZnS shell growth on CdSe, a standard stock solution of 0.0701 g ZnDDTC₂ dissolved in 19 mL of TOP (10 μM ZnDDTC₂) was used. Standard shell addition amounts were 0.7 mL of the ZnDDTC₂ solution in TOP mixed with 1.6 mL of oleylamine (as a sacrificial amine for the ZnDDTC₂ decomposition) and 10 mL of reacted nanorod solution. The reactants were mixed in a three-necked flask under nitrogen and pumped through the tube reactor at 110° C. for thirty minutes.

Unless otherwise stated, zinc selenide nanorod synthesis used the method reported in Acharya et al., Advanced Materials, 17, 2471(b) (2005). Nanowires were synthesized using 0.2035 g of selenium dissolved in 26 mL of oleylamine which was subjected to three cycles of vacuum and nitrogen purges for about 40 minutes at room temperature to remove oxygen. This selenium precursor solution was then heated to 200° C. under nitrogen forming a clear solution and subsequently cooled to around 70° C. Zinc stearate solution was used to supply zinc cation and was made by dissolving 0.8407 g of zinc stearate in 13 mL of oleylamine and heating to 150° C. The zinc stearate solution was added to the selenium solution under nitrogen, mixed, and cooled to 60° C. The nanowire synthesis occurred at 160° C. with a residence time of thirty minutes. Purification was performed following nanowire synthesis by centrifugation with a solution of 70:30 ethanol:methanol mixture. Following purification, the purified nanowire solution was diluted to its original volume with additional oleylamine. Nanorod synthesis occurred by running the purified nanowire solution through the reactor at a temperature of 260° C. and a residence time of twelve minutes.

Mixing sensitivity—The mixing for CdSe experiments was done offline by mixing the Cd and Se precursors in a three-neck flask; subsequently, the experiment was conducted by using a syringe pump to pump the mixture. For this synthesis, the reactants appear to have minimal sensitivity to mixing time at room temperature; spectra of a Cd+Se reagent mixture left overnight at room temperature yielded no fluorescence or particle formation. Based on this result, mixing could be done on a larger scale over the course of hours, simplifying reactor design and minimizing the need for microscale inline mixers. Cold offline mixing appears equivalent to cold inline mixing, allowing for the heating up method where the premixed reactants are rapidly heated to the reaction temperature.

Characterization. The solutions were typically diluted 1:40 in chloroform to obtain absorbance between 0.02 and 0.05 absorbance units (substantial additional dilution was required for some samples) and absorption/PL spectra were measured in solution without additional purification or size selection. Absorption spectra were obtained from an Agilent 8453 UV-Vis Diode Array System spectrophotometer and PL spectra were obtained from a Horiba Jobin-Yvon Fluoromax-3 spectrofluorimeter. A 490 nm excitation wavelength was used for CdSe particles and 350 nm for ZnSe particles for PL measurements. Relative PL QYs were determined by comparing to a quinine sulfate solution in 0.1 M H₂SO₄ (58% quantum yield). For TEM, ICP-OES and XRD measurements, the reaction products were thoroughly washed with 70:30 ethanol:methanol mixture and the precipitate was collected using a centrifuge. The purified products were then redissolved in choloroform for TEM imaging. Also, parts of the redissolved products were dried for ICP-OES and XRD measurements. ICP-OES were obtained on a PerkinElmer 2000DV optical emission spectrometer. Powder X-ray diffraction patterns were collected using a Bruker D8 Venture equipped with a four-circle κ diffractometer and a photon 100 detector.

### Example 4: Additional Syntheses of Nanostructure Materials

In this example, InP/ZnS cores-shell particles were produced. The reactor system utilized generally corresponds to the system and units shown in FIG. 3B and described in Example 2 above. Indium acetate (99.5%), Myristic acid (Sigma grade, >99%), Octadecene (technical grade, 90%), Oleic acid (90%), Octylamine (99%), Trioctylphosphine (TOP) (90%), zinc stearate (technical grade), and Zinc diethyldithiocarbamate (ZnDDTC₂) (97%) were purchased from Sigma-Aldrich and used as received. Tris(trimethylsilyl)phosphine (>98%) was purchased from Strem Chemical and used as received. For a typical synthesis, 0.1 mmol of zinc stearate, 0.2 mmol of Oleic acid, 0.4 mL of Octylamine and 20 mL of Octadecene are stirred under inert atmosphere in a 3-neck flask (InP-flask) equipped with a condenser. The mixture is then heated to 120° C. until zinc stearate dissolves completely in Octadecene. 0.3 mmol of Indium myristate is premixed with 0.2 mmol of Tris(trimethylsilyl)phosphine and 3 mL Octadecene in a glovebox. The pre-mixed mixture is then transferred to the InP-flask under inert conditions. In a separate 3-neck flask (ZnS-flask), 1 mmol of Zinc diethyldithiocarbamate (dissolved in Trioctylphosphine), 0.4 mL of Octylamine, and 20 mL of Octadecene are stirred under inert conditions. The entire reactor setup (including the 3-neck flasks) is maintained at a pressure of 5 psi. The contents from the InP-flask are pumped into the first reactor set at 240° C. at flow rate of 2.4 mL/min (equivalent residence time of 2.67 min). Once the product starts to flow out of the second reactor (and starts approaching the static mixer) the second pump is turned on to pump the contents from the ZnS-flask at a flow rate of 2.4 mL/min. The two streams (product from the first reactor and the precursors from the ZnS-flask) mix well as they flow through the static mixer into the second reactor. The temperature for the second reactor is set at 190° C. The product from the second reactor flows into an absorbance and fluorescence flow cells that enables inline analysis of the product as it exits the second reactor.

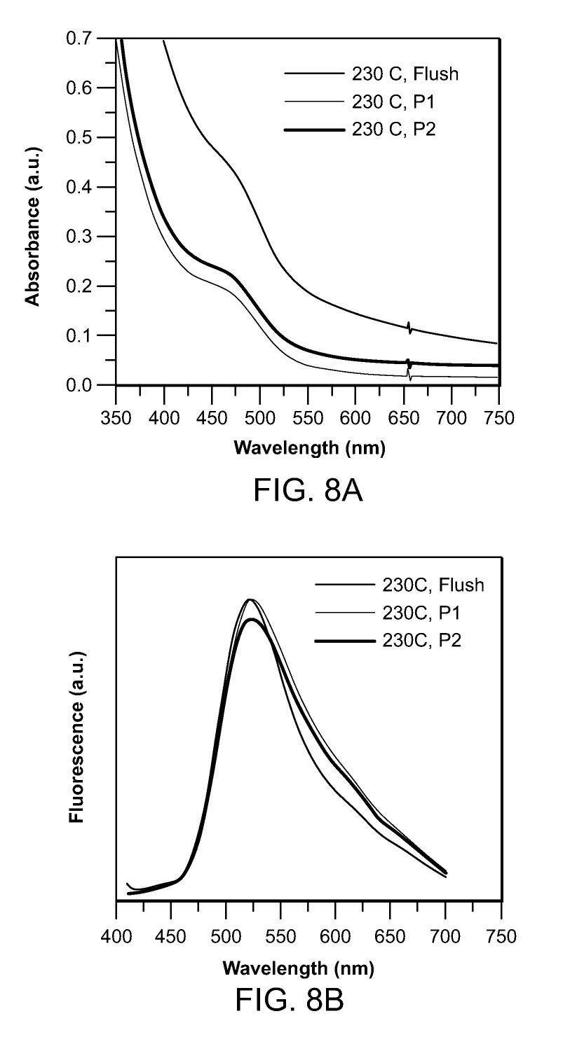

Preparation of Indium myristate stock solution. 3 mmol of indium acetate were mixed under inert atmosphere with the desired quantity (i.e. 4-8 mmol) of myristic acid (MA) and 30 mL of ODE in a 50 mL three neck flask equipped with a condenser. The mixture was heated to 100-120° C. for 1 h under vacuum to obtain an optically clear solution, backfilled with nitrogen, and then cooled down to room temperature. The prepared stock solution was stored in a glovebox. The synthesized InP/ZnS core-shell dots showed luminescence in the yellow region (see FIGS. 8A and 8B).

### Example 5: Additional Syntheses of Nanostructure Materials

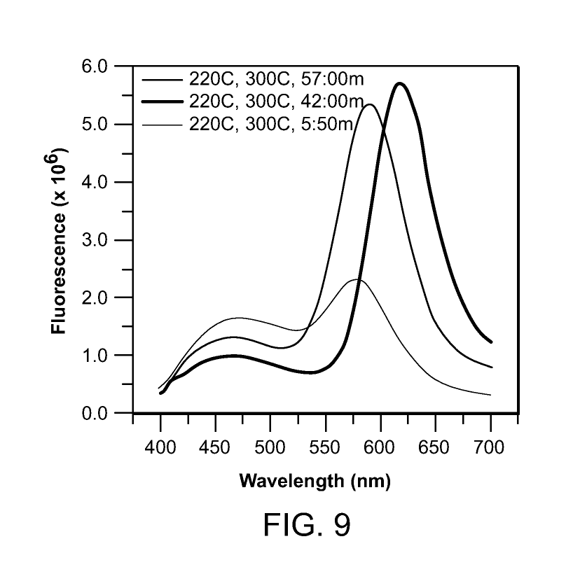

In this example, InP/ZnSeS core/shell particles were produced. The reactor system utilized generally corresponds to the system and units shown in FIG. 3B and described in Example 2 above. The InP core material is generally prepared as described in Example 4 above. Indium acetate (99.5%), Myristic acid (Sigma grade, >99%), Octadecene (technical grade, 90%), Oleic acid (90%), Octylamine (99%), Selenium (99.99%), Sulfur, Trioctylphosphine (TOP) (90%), and zinc acetate (99.99%) were purchased from Sigma-Aldrich and used as received. Tris(trimethylsilyl)phosphine (>98%) was purchased from Strem Chemical and used as received. For a typical synthesis, 0.2 mmol of zinc stearate, 0.4 mmol of Oleic acid, 0.4 mL of Octylamine and 20 mL of Octadecene are stirred under inert atmosphere in a 3-neck flask (InP-flask) equipped with a condenser. The mixture is then heated to 120° C. until zinc stearate dissolves completely in Octadecene. 0.3 mmol of Indium myristate is premixed with 0.2 mmol of Tris(trimethylsilyl)phosphine and 3 mL Octadecene in a glovebox. The pre-mixed mixture is then transferred to the InP-flask under inert conditions. In a separate 3-neck flask (ZnSeS-flask), 5 mmol of Zinc acetate, 4 mL of Oleic, acid and 16 mL of Octadecene are stirred under inert conditions until Zinc Acetate dissolves to form Zinc Oleate. 0.3 mL of TOP-Se (1 M solution) is premixed with 3 mL of TOP-S (1 M solution) or 4 mL of Dodecanethiol in a glovebox The premixed solution is injected into the ZnSeS-flask. The entire reactor setup (including the 3-neck flasks) is maintained at a pressure of 5 psi. The contents from the InP-flask are pumped into the first reactor set at 220° C. at flow rate of 0.55 mL/min (equivalent residence time of ˜50 min). Once the product starts to flow out of the second reactor (and starts approaching the static mixer) the second pump is turned on to pump the contents from the ZnSeS-flask at a flow rate of 0.55 mL/min. The two streams (product from the first reactor and the precursors from the ZnS-flask) mix well as they flow through the static mixer into the second reactor. The temperature for the second reactor is set at 300° C. The product from the second reactor flows into an absorbance and fluorescence flow cells that enables inline analysis of the product as it exits the second reactor. The flow rates of the streams were changed to obtain particles of varying sizes. This method produces highly luminescent InP/ZnSeS core-shell particles with quantum yields exceeding 60%, see FIG. 9.

### Example 6: Additional Syntheses of Nanostructure Materials

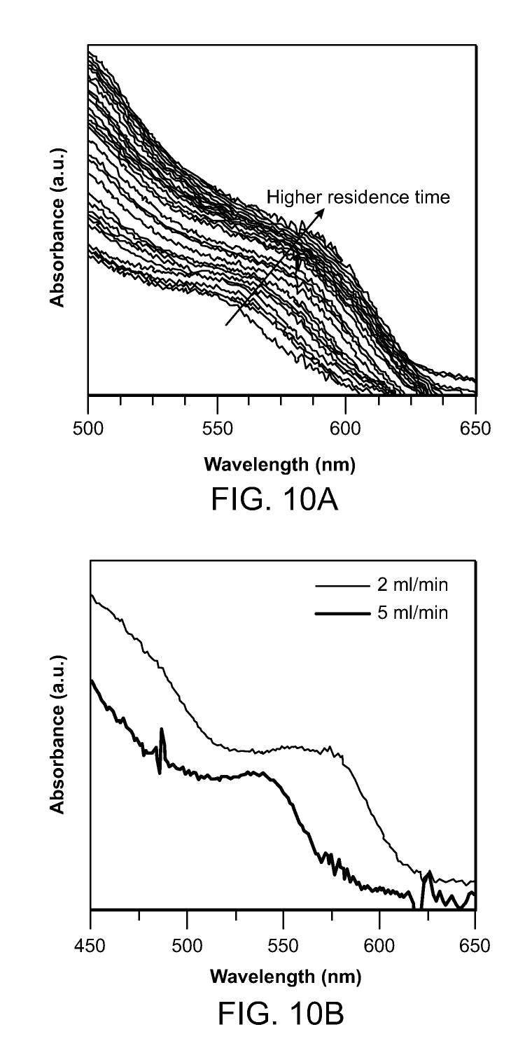

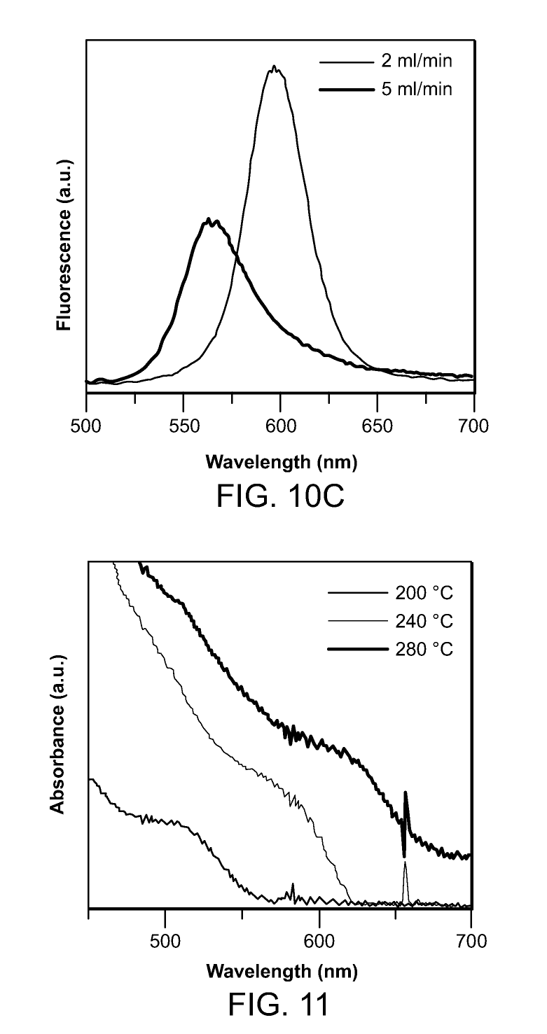

In this example, CdSe dots were produced. The reactor system utilized generally corresponds to the system and units shown in FIG. 3B and described in Example 2 above with an exception that only one reactor module was used. Cadmium Oxide (99.5%), Octadecene (technical grade, 90%), Oleic acid (90%), Selenium (99.99%), Sulfur, and Trioctylphosphine (TOP) (90%) were purchased from Sigma-Aldrich and used as received. Unless otherwise stated, the CdSe dots synthesis used 0.0684 g CdO (0.8 mmol) dissolved in 2.4 mL of oleic acid at 200° C. forming a clear Cd oleate solution. For synthesis of CdSe dots, TOP-Se solution was created by mixing 1.1844 g Se with 15 mL TOP in a glovebox before dissolving via sonication. For a standard synthesis, the prepared Cd oleate solution and 0.7 mL of the TOP-Se solution (1 M Se) were mixed with 47.6 mL Octadecene and pumped through the tube reactor, which was held at a set temperature of 220° C. with standard residence times (reactor volume/volumetric flow rate) of two and one half minutes (base case conditions). In order to explore the effects of the residence time, the residence time was varied from 1.5 min to 12.7 min (see FIG. 10A). Two distinct flow rates of 2 ml/min (residence time of 3.17 min) and 5 ml/min (1.8 min) were also tried. The corresponding absorbance (see FIG. 10B) and fluorescence spectra (see FIG. 10C) reveal that higher residence times result into bigger particles indicated by the red-shift of absorbance and fluorescence spectra. Additionally, we observed that higher reaction temperature at a set flow rate leads to the formation of bigger particles (see FIG. 11).

1. A continuous flow process for preparing nanostructure materials, comprising:
heating one or more nano structure material reagents by 100° C. or more within 5 seconds or less; and
reacting the nanostructure material reagents to form a nanostructure material reaction product.

2. A continuous flow process for preparing nanostructure materials comprising Cd, Zn or In, the process comprising:
flowing a fluid composition comprising one or more nanostructure material reagents through a reactor system; and
reacting the nanostructure material reagents to form a nanostructure material reaction product comprising Cd, In or Zn.

3. A continuous flow process for preparing nanostructure materials, comprising:
a) flowing one or more nanostructure material reagents through a first reaction unit
b) cooling the one or more nanostructure material reagents or reaction product thereof that have flowed through the first reaction unit; and
c) flowing the cooled one or more nanostructure material reagents or reaction product thereof through a second reaction unit.

4. A continuous flow process for preparing nanostructure materials, the process comprising:
flowing a fluid composition comprising one or more nanostructure material reagents through a reactor system at a predetermined rate and/or heating the flowing one or more nanostructure material at a predetermined temperature to provide nanostructure material reaction product that provides a desired emission wavelength.

5. The process of claim 1 further comprising cooling the reaction product by at least 100° C. within 5 seconds or less.

6. The process of claim 1 wherein a fluid composition comprising the one or more nanostructure material reagents flows through a reactor system during heating and reacting and cooling.

7. The process of claim 6 wherein the reactor system is 1) modular design, 2) comprises multiple reactor units, and/or 3) is a millifluidic system.

8. The process of claim 1 wherein the one or more nanostructure material reagents or fluid composition are monitored to detect one or more selected properties, and the one or more detected properties are modified bases on a detected value.

9. The process of claim 8 wherein the visible fluorescence properties of the product are detected, and further reactor synthetic output is subsequently modified based on the detected response characteristics by tuning operating conditions.

10. The process of claim 1 wherein at least one reagent and/or the reaction product comprises Zn, S Se, In, or Te.

11. The process of claim 1 wherein the nanostructure materials comprise quantum materials, fluorescent dyes or phosphors.

12. The process of claim 1 wherein the reaction occurs in excess of 400° C.

13. The process of claim 1 wherein 1) the particle size distribution of the nanostructure material reaction product has a standard deviation of less than 10 nm and/or 2) the fwhm of the visible wavelength primary fluorescence of the nanostructure material reaction product is less than 50 nm.

14. The process of claim 1 wherein at least a portion of the nanostructure materials comprise a shape of substantially spherical, ellipsoidal or non-elongated polyhedron, or a shape of a rod or a wire.

15. A continuous flow nanostructure material reaction system, comprising:
a) a first reaction unit for reacting one or more nanostructure material reagents;
b) a cooling unit for a reaction product of the first reaction unit; and
c) a second reaction unit for the cooled reaction product, followed by another cooling unit
wherein the first reaction unit, the cooling unit and the second reaction unit are arranged sequentially in the reaction system flow path.
